(19) United States
(12) Patent Application Publication
(10) Pub. No.: US 2020/0271468 A1
(43) Pub. Date: Aug. 27, 2020

(54) VEHICLE ALLOCATION SUPPORTING APPARATUS, PROGRAM, AND CONTROL METHOD

(71) Applicant: TOYOTA JIDOSHA KABUSHIKI KAISHA, Toyota-shi (JP)

(72) Inventors: Taiki Yoshida, Tokyo (JP); Saiko Toyoda, Nagoya-shi (JP)

(73) Assignee: TOYOTA JIDOSHA KABUSHIKI KAISHA, Toyota-shi (JP)

(21) Appl. No.: 16/775,868

(22) Filed: Jan. 29, 2020

(30) Foreign Application Priority Data
Feb. 26, 2019 (JP) 2019-033369

(51) Int. Cl. G01C 21/34; B60W 60/00; G05D 1/02

(52) U.S. Cl. CPC G01C 21/3438; G05D 1/021; B60W 60/00253

(57) ABSTRACT

There is provided a vehicle allocation supporting apparatus configured to support allocation of a vehicle configured to pick up and drop off a user. The vehicle allocation supporting apparatus includes a controller configured to determine a first destination, which is a point at which the vehicle picks up the user, when the controller detects that the user is using a first store or that the user has moved to the outside of the first store after finishing use of the first store, to determine a second store to which the user is guided next by searching a database showing information about a plurality of stores, to acquire information about the second store that is included in the information about the stores, and to determine a second destination, which is a point at which the vehicle drops off the user, based on the acquired information about the second store.

### CROSS-REFERENCE TO RELATED APPLICATION

This application claims priority to Japanese Patent Application No. 2019-033369 filed on Feb. 26, 2019, incorporated herein by reference in its entirety.

### BACKGROUND

### 1. Technical Field

The disclosure relates to a vehicle allocation supporting apparatus, a program, and a control method.

### 2. Description of Related Art

In the related art, there is a known technique in which a service providing facility such as a restaurant is proposed to a user in accordance with a preference of the user. For example, Japanese Unexamined Patent Application Publication No. 2017-076166 (JP 2017-076166 A) discloses an information processing device with which it is possible to recommend a service providing facility that matches a preference of a group of persons and is available to the group.

### SUMMARY

For example, a user who has finished use of a first store such as a restaurant may want to use a second store such as a restaurant other than the first store next. In this case, it is troublesome and inconvenient for the user to search for the second store that is available and to go to the second store by himself or herself.

The disclosure provides a vehicle allocation supporting apparatus, a program, and a control method with which it is possible to contribute to an improvement in convenience of a user who wants to use a second store after using a first store.

A first aspect of the disclosure relates to a vehicle allocation supporting apparatus configured to support allocation of a vehicle configured to pick up and drop off a user. The vehicle allocation supporting apparatus includes a controller configured to determine a first destination, which is a point at which the vehicle picks up the user, when the controller detects that the user is using a first store or that the user has moved to the outside of the first store after finishing use of the first store, to determine a second store to which the user is guided next by searching a database showing information about a plurality of stores, to acquire information about the second store that is included in the information about the stores, and to determine a second destination, which is a point at which the vehicle drops off the user, based on the acquired information about the second store.

A second aspect of the disclosure relates to a program running on a vehicle allocation supporting apparatus configured to support allocation of a vehicle configured to pick up and drop off a user. The program causes the vehicle allocation supporting apparatus to perform a step of detecting that the user is using a first store or that the user has moved to the outside of the first store after finishing use of the first store, a step of determining a first destination, which is a point at which the vehicle picks up the user, a step of determining a second store to which the user is guided next by searching a database showing information about a plurality of stores, and a step of acquiring information about the second store that is included in the information about the stores, and determining a second destination, which is a point at which the vehicle drops off the user, based on the acquired information about the second store.

A third aspect of the disclosure relates to a control method for a vehicle allocation supporting apparatus configured to support allocation of a vehicle configured to pick up and drop off a user. The method includes a step of detecting that the user is using a first store or that the user has moved to the outside of the first store after finishing use of the first store, a step of determining a first destination, which is a point at which the vehicle picks up the user, a step of determining a second store to which the user is guided next by searching a database showing information about a plurality of stores, and a step of acquiring information about the second store that is included in the information about the stores, and determining a second destination, which is a point at which the vehicle drops off the user, based on the acquired information about the second store.

With a vehicle allocation supporting apparatus, a program, and a control method according to the aspects of the disclosure, it is possible to contribute to an improvement in convenience of a user who wants to use a second store after using a first store.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a schematic configuration of an information processing system including a vehicle allocation supporting apparatus according to an embodiment of the disclosure;

FIG. 2 is a block diagram illustrating a schematic configuration of the vehicle allocation supporting apparatus according to the embodiment of the disclosure;

FIG. 3 is a diagram illustrating an example of information processed by a controller of the vehicle allocation supporting apparatus in FIG. 2;

FIG. 4 is a flowchart illustrating a first example of the flow of the operation of the vehicle allocation supporting apparatus in FIG. 2; and

FIG. 5 is a flowchart illustrating a second example of the flow of the operation of the vehicle allocation supporting apparatus in FIG. 2.

### DETAILED DESCRIPTION OF EMBODIMENTS

Hereinafter, an embodiment of the disclosure will be described with reference to attached drawings.

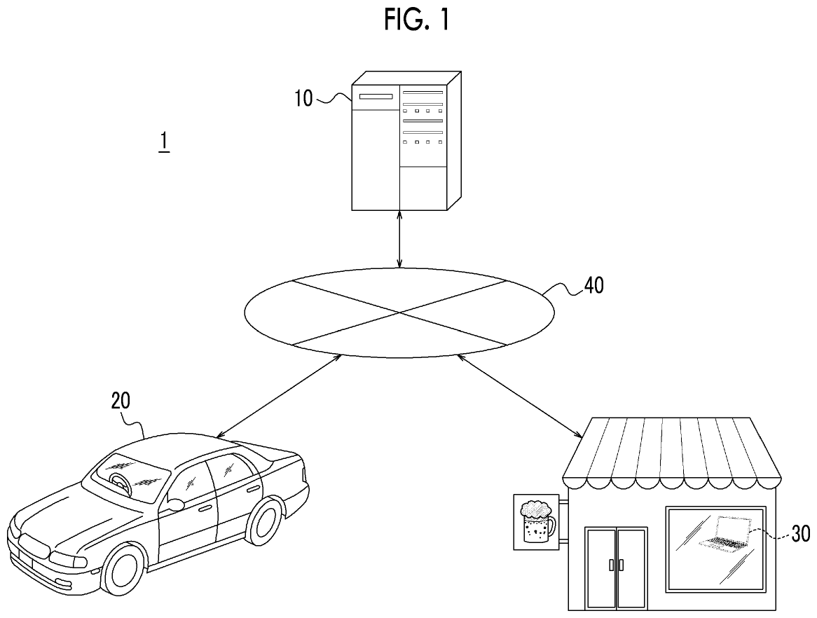

FIG. 1 is a diagram illustrating a schematic configuration of an information processing system 1 including a vehicle allocation supporting apparatus 10 according to an embodiment of the disclosure. With reference to FIG. 1, mainly the configuration and functions of the information processing system 1 including the vehicle allocation supporting apparatus 10 according to the embodiment of the disclosure will be described.

The information processing system 1 includes the vehicle allocation supporting apparatus 10, a vehicle 20, and information processing devices 30. Each of the vehicle allocation supporting apparatus 10, the vehicle 20, and the information processing devices 30 is connected to a network 40 such that the vehicle allocation supporting apparatus 10, the vehicle 20, and the information processing devices 30 can communicate with the network 40, examples of the network 40 including a mobile communication network and the Internet.

The vehicle allocation supporting apparatus 10 is, for example, one server apparatus or a plurality of server apparatuses that can communicate with each other. The vehicle allocation supporting apparatus 10 is not limited thereto. The vehicle allocation supporting apparatus 10 may be any general purpose electronic machine such as a personal computer (PC) or a smartphone and may be another electronic machine dedicated for the information processing system 1. The vehicle allocation supporting apparatus 10 supports allocation of the vehicle 20 that picks up a user at a first destination, which is a point at which the user who has finished use of a first store such as a restaurant is picked up, and drops off the user at a second destination correlated with a second store such as a restaurant other than the first store.

For example, the vehicle allocation supporting apparatus 10 acquires information about the user who is using the first store or who has finished use of the first store, from the information processing devices 30 via the network 40. Here, for example, the information about the user includes the attribute of the user including the sex of the user, the number of users, a sex ratio, an age group that the user belongs to, the clothes of the user, belongings of the user, the speech and action of the user, the nationality of the user, and the race of the user, the content of a service received in the first store, the purpose of use of the first store, a store leaving information of the first store, the date and time of use of the first store, and the financial situation of the user. The vehicle allocation supporting apparatus 10 may acquire the information about the user at all times and may acquire the information about the user at an appropriate timing.

For example, the vehicle allocation supporting apparatus 10 transmits various kinds of information determined in the vehicle allocation supporting apparatus 10 (which will be described later) to the vehicle 20 via the network 40.

The vehicle 20 is, for example, an automobile. However, the vehicle 20 is not limited to an automobile and the vehicle 20 may be any vehicle that a person can board. The vehicle 20 is a vehicle driven by a driver. However, the vehicle 20 is not limited thereto and may be an autonomous vehicle that is autonomously driven. Examples of autonomous driving include, levels one to five defined in the society of automotive engineers (SAE). However, the autonomous driving is not limited thereto and may be defined in any manner. For simplicity of description, one vehicle 20 is solely shown in FIG. 1. However, the number of vehicles 20 included in the information processing system 1 may be one or more.

For example, the vehicle 20 acquires the various kinds of information determined in the vehicle allocation supporting apparatus 10 (which will be described later) from the vehicle allocation supporting apparatus 10 via the network 40. Based on the information acquired from the vehicle allocation supporting apparatus 10, the vehicle 20 picks up the user who has finished use of the first store at the first destination and drops off the user at the second destination correlated with the second store other than the first store.

The information processing devices 30 include an information processing terminal in the first store in which a predetermined service is provided to the user. Such an information processing terminal may be any general purpose electronic machine such as a PC or a smartphone and may be another electronic machine dedicated for the information processing system 1. The information processing devices 30 transmit the information about the user who is using the first store or who has finished use of the first store to the vehicle allocation supporting apparatus 10 via the network 40.

The configurations of the information processing devices 30 are not limited thereto. For example, the information processing devices 30 may include any one of a control device that controls a camera of a vehicle positioned in the vicinity of the first store, a control device that controls a fixed-point camera installed in the vicinity of the first store, and an information processing terminal of the user who is using the first store or who has finished use of the first store in addition to or instead of the information processing terminal in the first store. The information processing terminal of the user may be any general purpose electronic machine such as a PC or a smartphone and may be another electronic machine dedicated for the information processing system 1.

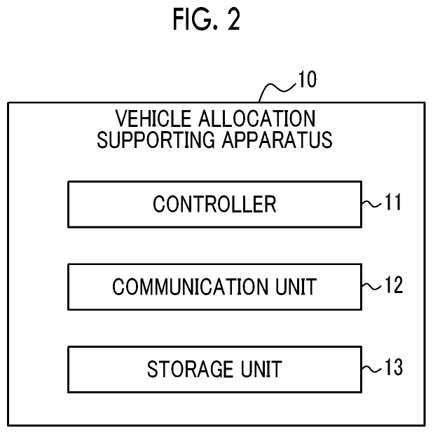

FIG. 2 is a block diagram illustrating a schematic configuration of the vehicle allocation supporting apparatus 10 according to the embodiment of the disclosure. With reference to FIG. 2, mainly the configuration of the vehicle allocation supporting apparatus 10 according to the embodiment of the disclosure will be described.

The vehicle allocation supporting apparatus 10 includes a controller 11, a communication unit 12, and a storage unit 13. Those components constituting the vehicle allocation supporting apparatus 10 are connected to each other in the vehicle allocation supporting apparatus 10 such that the components can communicate with each other.

The outline of the embodiment is as follows. The controller 11 of the vehicle allocation supporting apparatus 10 determines the first destination, which is a point at which the vehicle 20 picks up the user, when the controller 11 detects that the user is using the first store or that the user has moved to the outside of the first store after finishing use of the first store. In addition, the controller 11 determines the second store, to which the user is guided next, by searching a database showing information about a plurality of stores that is stored in the storage unit 13. The controller 11 acquires information about the second store included in the acquired information about the stores and determines the second destination, which is a point at which the vehicle 20 drops off the user, based on the information about the second store. The number of users may be one or more.

Next, each component of the vehicle allocation supporting apparatus 10 will be described in detail.

The controller 11 includes one or more processors. The “processor” in the embodiment is a general-purpose processor, a dedicated processor dedicated for a specific process, or the like. However, the processor is not limited thereto. The controller 11 is connected to each component constituting the vehicle allocation supporting apparatus 10 such that the controller 11 can communicate with each component and controls the operation of the entire vehicle allocation supporting apparatus 10. In the embodiment, for example, the controller 11 controls the communication unit 12 to acquire the information about the user from the information processing devices 30. For example, the controller 11 controls the communication unit 12 to transmit the various kinds of information determined in the vehicle allocation supporting apparatus 10 (which will be described later) to the vehicle 20 or the information processing terminal of the user.

The communication unit 12 includes a communication module connected to the network 40. For example, the communication unit 12 may include a communication module conforming to wired local area network (LAN) standards. In the embodiment, the vehicle allocation supporting apparatus 10 is connected to the network 40 via the communication unit 12.

The storage unit 13 includes one or more memories. In the embodiment, the “memories” are semiconductor memories, magnetic memories, optical memories, or the like. However, the memories are not limited thereto. Each memory included in the storage unit 13 may function as a main storage device, an auxiliary storage device, or a cache memory, for example. The storage unit 13 stores any information used to operate the vehicle allocation supporting apparatus 10. For example, the storage unit 13 may store a system program, an application program, various kinds of information acquired by the vehicle allocation supporting apparatus 10, or the like. Information stored in the storage unit 13 may be able to be updated with information that is acquired from the network 40 via the communication unit 12, for example.

The storage unit 13 stores the information about the user that the controller 11 acquires from the information processing devices 30 via the network 40. The storage unit 13 stores the database showing the information about the stores used to determine the second store to which the user is guided next. The information about a store includes any information such as position information of the store, the business hours of the store, the contents of a menu of the store, seat availability, and information about the result of evaluation performed by a user. The storage unit 13 may store, as big data, information about a store as described above for each of the stores. Information with a high real-time property like seat availability may be updated at any time with information that is acquired from the network 40 via the communication unit 12, for example.

Hereinafter, the operation of the controller 11 will be described in more detail.

The controller 11 detects that the user is using the first store or the user has moved to the outside of the first store after finishing use of the first store. For example, the controller 11 may detect that the user is using the first store based on the information about the user such as the contents of a service received in the first store, the purpose of use of the first store, and the date and time of use of the first store, the information about the user being acquired from the information processing terminal in the first store, which is included in the information processing devices 30. For example, the controller 11 may detect that the user has moved to the outside of the first store after finishing use of the first store based on store leaving information of the user acquired from the information processing terminal in the first store, which is included in the information processing devices 30. The store leaving information may include a date and time at which the user finishes use of a service in the first store. Such a date and time may be a date and time at which a payment process at the first store that is accompanied by user's use of a service is finished, for example.

For example, the controller 11 may detect that the user has moved to the outside of the first store after finishing use of the first store based on an image captured by at least one of the camera of the vehicle positioned in the vicinity of the first store and the fixed-point camera installed in the vicinity of the first store, which are included in the information processing devices 30. For example, such an image may include an image of the user moving to the outside of the first store from the inside of the first store and may include an image of a plurality of users gathering and talking in front of the first store.

For example, the controller 11 may detect that the user is using the first store or the user has moved to the outside of the first store after finishing use of the first store based on position information of the user that is acquired from the information processing terminal of the user, which is included in the information processing devices 30. For example, position information of the user as described above may include position information in the first store or position information in the vicinity of the first store.

When the controller 11 detects that the user is using the first store or the user has moved to the outside of the first store after finishing use of the first store, the controller 11 determines the first destination, which is a point at which the vehicle 20 picks up the user. The first destination may be in the vicinity of the first store and may be any other place distant from the first store.

The controller 11 may acquire current position information of the user when the controller 11 detects that the user has moved to the outside of the first store after finishing use of the first store. For example, the controller 11 may acquire position information of the user based on position information transmitted from the information processing terminal of the user, which is included in the information processing devices 30. For example, the position information of the user as described above may include position information in the vicinity of the first store or position information in any other place distant from the first store.

The controller 11 may determine, based on the acquired position information of the user, the first destination, which is a point at which the vehicle 20 picks up the user, when the controller 11 detects that the user has moved to the outside of the first store after finishing use of the first store.

The controller 11 determines the second store, to which the user is guided next, by searching the database showing the information about the stores that is stored in the storage unit 13, for example. For example, the controller 11 may determine both of the second store to which the user is guided next and the first destination based on the acquired position information of the user. For example, the controller 11 may determine the second store to which the user is guided next based on the information about the user that is acquired from the information processing devices 30 via the network 40. For example, the controller 11 may determine the second store by means of machine learning based on the information about the user that is acquired from the information processing devices 30. At this time, the controller 11 may determine the second store that suits the information about the user acquired from the information processing devices 30 and matches a preference of the user. The controller 11 may have any configuration for a machine learning process to perform such a determination process.

Hereinabove, it has been described that the controller 11 determines the second store based on the information about the user that is acquired from the information processing devices 30. However, a method in which the controller 11 performs a second store determination process is not limited thereto. The controller 11 may determine any second store by searching the database showing the information about the stores regardless of the information about the user.

The controller 11 acquires information about the second store which is included in the information about the stores and determines the second destination, which is a point at which the vehicle 20 drops off the user, based on the acquired information about the second store. The second destination may be in the vicinity of the second store and may be any other place distant from the second store. For example, the controller 11 may determine the second destination together with the first destination and the second store based on the acquired position information of the user.

For example, the controller 11 may determine the type of the vehicle 20 to be allocated, the number of the vehicles 20 to be allocated, the grade of the vehicle 20 to be allocated, and the like based on the information about the user in addition to or instead of determining the second store based on the information about the user as described above. For example, the controller 11 may determine the type of the vehicle 20 to be allocated, the number of the vehicles 20 to be allocated, the grade of the vehicle 20 to be allocated, and the like by means of machine learning based on the information about the user that is acquired from the information processing devices 30. At this time, the controller 11 may determine the type of the vehicle 20 and the number of the vehicles 20 that suit the information about the user acquired from the information processing devices 30 and match the composition of a user group. Similarly, the controller 11 may determine the grade of the vehicle 20 in accordance with the financial situation or the like of the user. The controller 11 may have any configuration for a machine learning process to perform such a determination process.

For example, the controller 11 may transmit various kinds of information that are determined through a series of determination processes as described above to the vehicle 20 and the information processing terminal of the user via the network 40. Accordingly, the driver of the vehicle 20 or the vehicle 20 as an autonomous vehicle can check information about a point at which the user is picked up, the second store to which the user is guided next, a point at which the user is dropped off, and the like. Similarly, the user can check the information about a point at which the user is picked up by the vehicle 20, the second store to which the user is guided next, a point at which the vehicle 20 drops off the user, and the like by means of the information processing terminal of the user.

The controller 11 may estimate a date and time at which the user moves to the outside of the first store after finishing use of the first store based on the information about the user that is acquired from the first store. For example, the controller 11 may estimate such a date and time by means of machine learning based on the information about the user that is acquired from the information processing devices 30. The controller 11 may have any configuration for a machine learning process to perform such an estimation process.

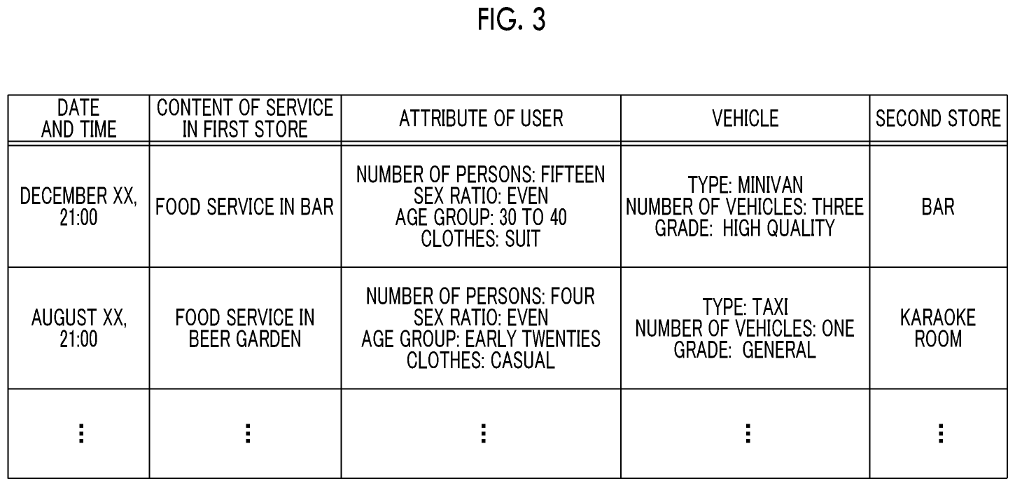

FIG. 3 is a diagram illustrating an example of information processed by the controller 11 of the vehicle allocation supporting apparatus 10 in FIG. 2. With reference to FIG. 3, an information determination process performed by the controller 11 of the vehicle allocation supporting apparatus 10 will be described more specifically.

For example, the controller 11 acquires store leaving information of the first store (more specifically, date and time at which user has finished use of service in first store) from the information processing devices 30 as the information about the user. For example, the controller 11 acquires the content of a service received by the user in the first store as the information about the user from the information processing devices 30. For example, the controller 11 acquires the attribute of the user including the number of users, a sex ratio, an age group that the user belongs to, and the clothes of the user as the information about the user from the information processing devices 30. For example, the controller 11 determines the second store to which the user is guided next and the type of the vehicle 20 to be allocated, the number of the vehicles 20 to be allocated, the grade of the vehicle 20 to be allocated, and the like by means of machine learning based on the information about the user as described above.

In a certain specific example, the controller 11 acquires information indicating December XX, 21:00 as a date and time at which users have finished use of a service in the first store. At this time, the controller 11 acquires information indicating a food service in a bar as the content of a service received by the users in the first store. The controller 11 acquires information indicating that the number of the users is fifteen, the sex ratio is even, the users belong to the 30-40 age group, and the clothes of the users are suits as the attributes of the users. The controller 11 determines “minivan” as the type of the vehicles 20 to be allocated, “three” as the number of the vehicles 20 to be allocated, and “high-grade model” as the grade of the vehicles 20 to be allocated based on the information about the users. The controller 11 determines, for example, another bar as the second store to which the users are guided next, based on the information about the users.

In another specific example, the controller 11 acquires information indicating August XX, 21:00 as a date and time at which users have finished use of a service in the first store. At this time, the controller 11 acquires information indicating a food service in a beer garden as the content of a service received by the users in the first store. The controller 11 acquires information indicating that the number of the users is four, the sex ratio is even, the users are early twenties, and the clothes of the users are casual as the attributes of the users. The controller 11 determines “taxi” as the type of the vehicle 20 to be allocated, “one” as the number of the vehicles 20 to be allocated, and “general model” as the grade of the vehicle 20 to be allocated based on the information about the users. The controller 11 determines, for example, a karaoke room as the second store to which the users are guided next, based on the information about the users.

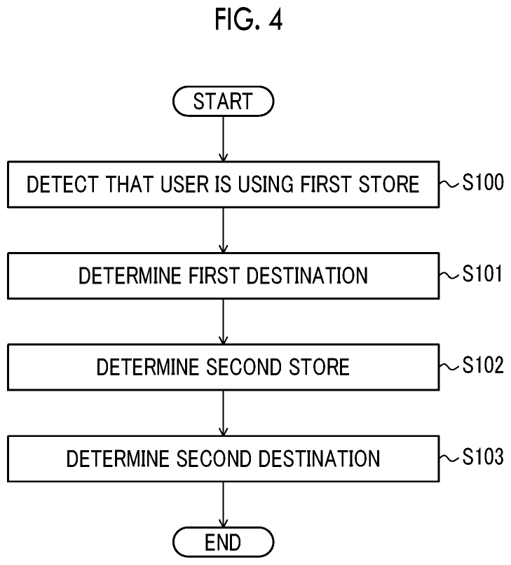

FIG. 4 is a flowchart illustrating a first example of the flow of the operation of the vehicle allocation supporting apparatus 10 in FIG. 2. FIG. 4 illustrates how the flow of the operation of the vehicle allocation supporting apparatus 10 is when the controller 11 of the vehicle allocation supporting apparatus 10 detects that the user is using the first store. With reference to FIG. 4, mainly the first example of the flow of the operation of the vehicle allocation supporting apparatus 10 will be described.

Step S100: The controller 11 of the vehicle allocation supporting apparatus 10 detects that the user is using the first store.

Step S101: The controller 11 determines the first destination, which is a point at which the vehicle 20 picks up the user.

Step S102: The controller 11 determines the second store to which the user is guided next by searching the database showing the information about the stores.

Step S103: The controller 11 acquires the information about the second store included in the information about the stores and determines the second destination, which is a point at which the vehicle 20 drops off the user, based on the acquired information about the second store.

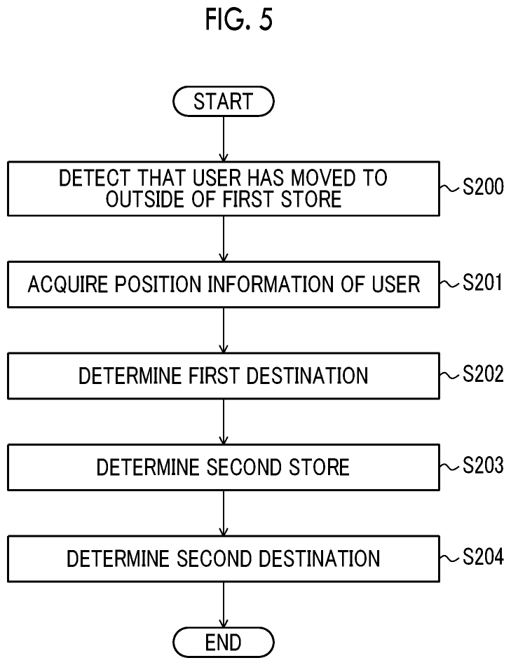

FIG. 5 is a flowchart illustrating a second example of the flow of the operation of the vehicle allocation supporting apparatus 10 in FIG. 2. FIG. 5 illustrates how the flow of the operation of the vehicle allocation supporting apparatus 10 is when the controller 11 of the vehicle allocation supporting apparatus 10 detects that the user has moved to the outside of the first store after finishing use of the first store. With reference to FIG. 5, mainly the second example of the flow of the operation of the vehicle allocation supporting apparatus 10 will be described.

Step S200: The controller 11 of the vehicle allocation supporting apparatus 10 detects that the user has moved to the outside of the first store after finishing use of the first store.

Step S201: The controller 11 acquires position information of the user.

Step S202: The controller 11 determines, based on the acquired position information of the user, the first destination, which is a point at which the vehicle 20 picks up the user.

Step S203: The controller 11 determines the second store, to which the user is guided next, by searching the database showing the information about the stores.

Step S204: The controller 11 acquires the information about the second store included in the information about the stores and determines the second destination, which is a point at which the vehicle 20 drops off the user, based on the acquired information about the second store.

As described above, with the vehicle allocation supporting apparatus 10 according to the embodiment, it is possible to contribute to an improvement in convenience of a user who wants to use the second store after using the first store. For example, there is an improvement in convenience of a user who uses a vehicle allocation service provided by the vehicle allocation supporting apparatus 10. More specifically, the user does not need to search for the second store that is available by himself or herself since the vehicle allocation supporting apparatus 10 determines the second store to which the user is guided next. The user does not need to acquire position information of the second store and to go to the second store by himself or herself since the vehicle allocation supporting apparatus 10 determines the second destination based on the acquired information about the second store and supports allocation of the vehicle 20 that picks up the user at the first destination and drops off the user at the second destination. As described above, even in a case where the user finishes use of the first store and wants to use the second store next, the user can move to the second store from the first store smoothly.

Since the vehicle allocation supporting apparatus 10 detects that the user has moved to the outside of the first store after finishing use of the first store based on an image captured by at least one of the camera of the vehicle positioned in the vicinity of the first store and the fixed-point camera installed in the vicinity of the first store, it is possible to directly detect that the user has moved to the outside of the first store after finishing use of the first store based on visual information obtained from the image. The vehicle allocation supporting apparatus 10 can accurately detect that the user has moved to the outside of the first store after finishing use of the first store, based on such visual information.

Since the vehicle allocation supporting apparatus 10 performs the series of determination processes based on the acquired position information of the user when the vehicle allocation supporting apparatus 10 detects that the user has moved to the outside of the first store after finishing use of the first store, it is possible to appropriately determine the first destination, the second store, and the second destination based on current position information of the user. For example, even in a case where the user walks at a place distant from the first store, the vehicle allocation supporting apparatus 10 can appropriately perform the series of determination processes in accordance with the current position information of the user regardless of position information of the first store. As a result, there is an improvement in convenience of a user who wants to use the second store after using the first store.

Since the vehicle allocation supporting apparatus 10 acquires position information of the user based on position information transmitted from the information processing terminal of the user, it is possible to accurately acquire the current position information of the user. Accordingly, the vehicle allocation supporting apparatus 10 can appropriately determine the first destination, which is a point at which the vehicle 20 picks up the user. As a result, there is an improvement in convenience of a user who wants to use the second store after using the first store.

Since the vehicle allocation supporting apparatus 10 determines the second store based on the information about the user, it is possible to accurately determine the second store in which an appropriate service matching a preference of the user is provided. Similarly, since the vehicle allocation supporting apparatus 10 determines the type of the vehicle 20 to be allocated and the number of the vehicles 20 to be allocated based on the information about the user, it is possible to accurately determine the type of the vehicle 20 and the number of the vehicles 20 suitable for the composition of a user group. Since the vehicle allocation supporting apparatus 10 determines the grade of the vehicle 20 to be allocated based on the information about the user, it is possible to accurately determine the grade of the vehicle 20 suitable for the financial situation or the like of the user. Accordingly, for example, the degree of satisfaction of a user who uses a vehicle allocation service provided by the vehicle allocation supporting apparatus 10 is improved.

Since the vehicle allocation supporting apparatus 10 estimates a date and time at which the user moves to the outside of the first store after finishing use of the first store based on the information about the user that is acquired from the first store, it is possible to accurately perform the determination processes relating to the first destination, the second store, and the second destination even at a time when the user uses the first store. The vehicle allocation supporting apparatus 10 can transmit various kinds of information determined through the series of the determination processes to the information processing terminal of the user in advance before the user finishes use of the first store. Accordingly, for example, a user who uses a vehicle allocation service provided by the vehicle allocation supporting apparatus 10 can move to the second destination smoothly without waiting for arrival of the vehicle 20 for a longer time than necessary after the user finishes use of the first store.

Similarly, since the vehicle allocation supporting apparatus 10 estimates a date and time at which the user moves to the outside of the first store after finishing use of the first store, it is also possible to accurately detect that the user has moved to the outside of the first store after finishing use of the first store by comparing the result of estimation and the result of detection.

Since the vehicles 20 to be allocated include an autonomous vehicle, the vehicle allocation supporting apparatus 10 can provide a vehicle allocation service, in which allocating the vehicle 20 to the first destination, picking up a user at the first destination, dropping off the user at the second destination are all performed autonomously, to a user.

It is clear to those skilled in the art that the disclosure can be implemented in a predetermined form other than the above-described embodiment without departing from the spirit and the essential features of the present disclosure. Accordingly, the above description is merely an example and the disclosure is not limited thereto. The scope of the disclosure is defined by the attached claims, not the above description. It will be assumed that some of various modifications that are within a scope equivalent thereto are included therein.

For example, the arrangement of the components above described and the number thereof are not limited to those in the above description and the drawings. The arrangement of the components above described and the number thereof may be randomly set as long as the functions thereof can be realized.

For example, each step in the operation of the vehicle allocation supporting apparatus 10, the functions or the like included in each step, or the like can be rearranged without logical inconsistency, the order in which the steps are arranged can be changed, and a plurality of steps can be combined with each other or be divided.

For example, the disclosure can also be realized as a program in which the contents of a process of realizing the functions of the vehicle allocation supporting apparatus 10 as described above are written or a storage medium in which the program is recorded. Note that, those above described are also included in the scope of the disclosure.

In the above-described embodiment, it has been described that the vehicle allocation supporting apparatus 10 and the vehicle 20 are connected to each other via the network 40 such that the vehicle allocation supporting apparatus 10 and the vehicle 20 can communicate with each other. However, the disclosure is not limited to the above-described embodiment in which a server apparatus that is connected to the network 40 such that the server apparatus can perform communication functions as the vehicle allocation supporting apparatus 10 and for example, an embodiment in which any vehicle-mounted device installed in the vehicle 20 functions as the vehicle allocation supporting apparatus 10 can also be realized.

What is claimed is:

1. A vehicle allocation supporting apparatus configured to support allocation of a vehicle configured to pick up and drop off a user, the apparatus comprising a controller configured to determine a first destination, which is a point at which the vehicle picks up the user, when the controller detects that the user is using a first store or that the user has moved to an outside of the first store after finishing use of the first store, to determine a second store to which the user is guided next by searching a database showing information about a plurality of stores, to acquire information about the second store that is included in the information about the stores, and to determine a second destination, which is a point at which the vehicle drops off the user, based on the acquired information about the second store.

2. The vehicle allocation supporting apparatus according to claim 1, wherein the controller detects that the user has moved to the outside of the first store after finishing use of the first store based on an image captured by at least one of a camera of a vehicle positioned in a vicinity of the first store and a fixed-point camera installed in the vicinity of the first store.

3. The vehicle allocation supporting apparatus according to claim 1, wherein the controller acquires position information of the user when the controller detects that the user has moved to the outside of the first store after finishing use of the first store and determines the first destination, the second store, and the second destination based on the acquired position information of the user.

4. The vehicle allocation supporting apparatus according to claim 3, wherein the controller acquires the position information of the user based on position information transmitted from an information processing terminal of the user.

5. The vehicle allocation supporting apparatus according to claim 1, wherein the controller determines, based on information about the user, at least one of the second store to which the user is guided next and a type of the vehicle.

6. The vehicle allocation supporting apparatus according to claim 1, wherein the controller estimates a date and time at which the user moves to the outside of the first store after finishing use of the first store based on information about the user that is acquired from the first store.

7. The vehicle allocation supporting apparatus according to claim 1, wherein vehicles to be allocated include an autonomous vehicle.

8. A program running on a vehicle allocation supporting apparatus configured to support allocation of a vehicle configured to pick up and drop off a user, the program causing the vehicle allocation supporting apparatus to perform
a step of detecting that the user is using a first store or that the user has moved to an outside of the first store after finishing use of the first store,
a step of determining a first destination, which is a point at which the vehicle picks up the user,
a step of determining a second store to which the user is guided next by searching a database showing information about a plurality of stores, and
a step of acquiring information about the second store that is included in the information about the stores, and determining a second destination, which is a point at which the vehicle drops off the user, based on the acquired information about the second store.

9. A control method for a vehicle allocation supporting apparatus configured to support allocation of a vehicle configured to pick up and drop off a user, the method comprising:
a step of detecting that the user is using a first store or that the user has moved to an outside of the first store after finishing use of the first store;
a step of determining a first destination, which is a point at which the vehicle picks up the user;
a step of determining a second store to which the user is guided next by searching a database showing information about a plurality of stores; and
a step of acquiring information about the second store that is included in the information about the stores, and determining a second destination, which is a point at which the vehicle drops off the user, based on the acquired information about the second store.
